(19) United States
(12) Patent Application Publication
(10) Pub. No.: US 2007/0215552 A1
(43) Pub. Date: Sep. 20, 2007

(54) Systems and methods for removal of contaminates from an aqueous media in the absence of modified nitrate levels

(75) Inventors: Charles S. Williams, Golden, CO (US); Scott E. Heffner, Golden, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: WRT International LLC., Arvada, CO (US)

(21) Appl. No.: 11/532,391

(22) Filed: Sep. 15, 2006

Related U.S. Application Data
(60) Provisional application No. 60/717,653, filed on Sep. 16, 2005.

(51) Int. Cl. C02F 1/42

(52) U.S. Cl. 210/683; 423/6; 210/684

(57) ABSTRACT

Systems and methods are provided for the removal of contaminates from an aqueous medium using an anion exchange based material. The systems and methods include an optimized relationship between the removal of the contaminate and unmodified discharged levels of nitrate.

### CROSS-REFERENCE TO RELATED APPLICATIONS

The present disclosure claims the benefit under 35 U.S.C. § 119(e) of U.S. Patent Application No. 60/717,653, filed Sep. 16, 2005, U.S. Patent Application No. 60/515,921, filed Oct. 29, 2003, and U.S. Patent Application No. 60/619,369 filed Oct. 15, 2004, all of which are hereby incorporated by reference in their entirety.

### BACKGROUND OF THE INVENTION

a. Field of the Invention

The invention generally relates to methods and systems for minimizing nitrate dumping during contaminate removal from an aqueous medium. More specifically, the invention provides methods and systems for minimizing nitrate interaction and subsequent release from an anion exchange resin during the removal of contaminates from an aqueous medium.

b. Background Art

Cities and towns throughout the world depend on having clean potable water supplies. The dependence on clean water has increased as the population of the world has increased, especially as industrial use of rivers and lakes have become commonplace. The increased industrial use of fresh water supplies has resulted in a corresponding decrease in water quality throughout the world, due principally to industrial related release of contaminates into the water supplies. The decrease in water quality is contravening to the world's increased dependence on clean potable water supplies, requiring a concerted effort toward both minimizing the release of contaminates into the water supplies and removing existing contaminates in water supplies throughout the world.

Conventional water treatment facilities are often equipped with specialized systems for removal of target contaminates from a water supply. For example, contacting the water supply with an affinity material having sorptive qualities toward the target contaminate of concern in the water source. Typically, these sorptive materials are constrained in a column that receives the water source and passes the water source back to a traditional water treatment facility after specialized treatment.

A number of target contaminates can be removed from aqueous medium when contacted to anion exchange material or resin. For example, removal of uranium from an aqueous medium has previously been described in U.S. Provisional Patent Application 60/619,369, filed Oct. 15, 2004.

A by-product of anion exchange based procedures is the removal and concentration of other negatively charged, non-target, anions onto the same anion exchange material. Importantly, removal of uranium from an aqueous medium is often accompanied by removal of nitrate from the same aqueous medium. However, unlike uranium, which has high binding interactions for most anion exchange materials, nitrate typically has lower binding interaction, for example, as compared to uranium, for the same anion exchange resin. This is termed selectivity, uranium having a higher selectivity than nitrate for the same resin. However, since nitrate is typically at much higher levels in a target aqueous medium (often due to agricultural fertilizer use), it will still tend to interact and concentrate on the anion resin, as many sites are often available on the resin for such interactions.

In general, nitrate tends to be replaced and released from an anion exchange material when other negatively charged pollutants or chemicals are present within the aqueous medium. For example, sulfate tends to also be at higher concentrations in aqueous medium, and can compete with nitrate on some anion exchange material for binding sites. Since sulfate tends to have a higher selectivity than nitrate for these anion exchange binding site it tends to displace the nitrate back into the aqueous medium for release from the anion exchange material. Other factors also modify nitrate interaction with most materials or resins, for example, changes in pH, concentrations of different anions in the medium, etc. In each case, bound nitrate can be released from some anion exchange materials in a variable and inconsistent manner.

Presently, the Maximum Contaminant Level (MCL) for nitrate in drinking water is 10 parts per million (ppm). As such, small fluxes in nitrate levels within the drinking water have large issues with regard to drinking water compliance. One major contributor to nitrate fluxuation within drinking water is the inconsistent and variable release of nitrate from anion exchange resins used to remove other contaminates from the same medium. This inconsistent and variable release of a concentrated amount of nitrate into an aqueous medium can cause the medium to fail nitrate level compliance as well as result in potential health risk(s) to the aqueous medium user(s). In addition, an aqueous medium that appears to not have a nitrate issue will not be targets for adjunct remediation consideration, like resins specifically designed to remove nitrate.

One aspect of the present invention is to avoid the inconsistent or variable release of nitrate from an anion exchange resin when the anion exchange resin is used to remove other target pollutants by limiting or eliminating nitrates from loading onto the anion exchange resin.

Against this backdrop the present invention was developed.

### BRIEF SUMMARY OF THE INVENTION

The present invention provides systems, methods and compositions for the removal of target anion pollutants from an aqueous medium while inhibiting the removal of other anions from the same aqueous medium. Such systems, methods and compositions are based on the differential or selective binding capacity of target materials, e.g., resins, for anions, such that nitrate is not removed from the aqueous medium.

In one aspect, the present invention provides methods, systems and compositions for differential binding and removal of target contaminates from an aqueous medium via an anion exchange material or resin. Target contaminates are selectively removed from aqueous medium while minimizing the capacity of the anion exchange material to interact with nitrate. Differential modification of anion exchange material is utilized to maximize target contaminate removal while allowing nitrate to pass through the anion exchange material with the discharged and treated aqueous medium. In preferred aspects, the nitrate level in the aqueous medium is maintained at a substantially constant or consistent level. In preferred aspects the nitrate levels in the aqueous medium do not substantially fluxuate during treatment of the aqueous medium for another target contaminate. In some aspects where the nitrate levels are above the MCL, a second devoted anion exchange type material is used to target and remove nitrate.

In one embodiment, an anion exchange material of the present invention is treated with a blocking anion to selectively block binding sites for nitrate, while allowing for interaction and removal of other contaminates onto the anion exchange material. The blocking anion is determined from it's capacity to block nitrate interaction with the anion exchange material but fail to block contaminate interaction with the same anion exchange resin. Discharged medium from the anion exchange material has a lower level of contaminate than input level, while maintaining the same or substantially the same level of nitrate, i.e., consistent or non-variable. Preferred blocking anion is either safe or is less hazardous than nitrate in discharged aqueous medium. In some embodiments, the blocking anion is a sulfate or bisulfate group.

The embodiments of the invention provide that nitrate levels will remain relatively stable within the aqueous medium during and after treatment on an anion exchange material. In a preferred embodiment, the contaminate is uranium and the blocking anion is sulfate. In other embodiments, the contaminate is uranium, the blocking anion is sulfate and the nitrate levels in the discharge remain consistent (do not spike).

These and various other features as well as advantages which characterize the invention will be apparent from a reading of the following detailed description and a review of the appended claims.

### BRIEF DESCRIPTION OF THE DRAWINGS

FIG. 1 is an illustrative flow diagram for one method for negatively selecting nitrate from an aqueous medium being treated by an anion exchange resin.

FIG. 2 is a schematic of resin treatment with a blocking anion in accordance with one embodiment of the present invention.

### DETAILED DESCRIPTION OF THE INVENTION

Definitions:

The following definitions are provided to facilitate understanding of certain terms used frequently herein and are not meant to limit the scope of the present disclosure.

“Aqueous medium” or “aqueous media” refers to water or any liquid made with water as a constituent. Included with “aqueous medium” is water for consumption and/or personal use (e.g. “potable water”), as well as water not intended for consumption but needs treatment for removal of contaminants, e.g. uranium. “Aqueous medium” thus including drinking water and water that if treated, will be suitable for drinking, particularly by humans but animals as well. “Aqueous medium” also includes wastewater, such as results from industrial or agricultural processes. “Treated aqueous medium” thus means an aqueous medium treated using the methods and compositions of the invention. In some cases, aqueous medium or media of the present invention can comprise some level of nitrate. For example, an aqueous medium can be a ground water supply contaminated with U²³⁸ based anion complex, and the water supply contains nitrate, and preferably nitrate at a level less than the MCL for nitrate.

“Blocking anion” refers to an anion that competes with nitrate for binding to an anion exchange resin, but is effectively displaced from the anion exchange resin by a target contaminate. Illustrative blocking anions for use in the present invention are therefore determined by the type of anion exchange resin being used, the identity of the contaminate and the levels and amounts of the nitrate in the aqueous medium. In one embodiment, the blocking anion has a selectivity within the aqueous medium intermediate between the contaminate and the nitrate. In another embodiment the blocking anion is sulfate or bisulfate, and is most preferable sulfate.

“Feed” refers to an aqueous medium before treatment with the systems, methods and/or compositions of the present invention, for example, a feed may be a flowing water source before it enters an anion exchange resin of the present invention.

“Maximum Contaminant Level” or “MCL” is the highest level of contamination that is allowed by the Environmental Protection Agency for a particular contaminate in drinking water in the United States. The MCL takes into account best treatment technology and cost. The MCL standards are typically enforceable. Note that for purposes of the present disclosure, Maximum Contaminant Level standards are envisioned to encompass or correspond to the same approximate standards in countries outside the United States, and in many cases are enforceable in those countries.

“Contaminate” refers to a material within an aqueous medium having sorptive characteristics consistent with removal by an anion exchange resin of the invention. Contaminates of the present invention include, but are not limited to, uranium-234, uranium-235, uranium-238, uranium carbonate, uranium sulfate, chromium, iron sulfate, and the like.

“Remove” refers to the detectable decrease of a target material, for example, uranium, from a feed or source. Typically, removal of a target material, e.g., uranium, from an aqueous source is at least 50% of the starting or feed level, preferably at least 75% of the starting or feed level, and most preferably to the below the MCL for the target material. Typically, the concentration of the uranium or other like contaminate in the aqueous medium is changed from a first level to a second lower lever using embodiments of the present invention. In some cases as outlined herein, some components of the water system are not removed, e.g. nitrates; in this embodiment, a component may be “substantially not removed” or “substantially remain” in the water. In this context, “substantially” means at least 70% of the starting amount is still present, with embodiments utilizing at least 75, 80, 85, 90, 95 and 98% all being possible.

“Absorb” and “adsorb” refer to the same basic principle of one substance being retained by another substance. The processes can include attraction of one substance to the surface of another substance or the penetration of one substance into the inner structure of another substance. For example, the present invention contemplates that anion exchange materials or resins can either absorb and/or adsorb uranium out of an aqueous medium, and that for purposes of the present invention, the two principles are interchangeable. Other terms used to describe this interaction include sorption, binding, or trapping, each of which is contemplated to be within and interchangeable with the definition of absorption and/or adsorption.

“Anion exchange material” refers to materials having sorptive characteristics for uranium or other like contaminates in the context of the present invention. Typical materials for use in the present invention are considered “anion” exchange and can include strong-base anion exchange resins. These anion exchange materials and resins are selective and interact with different anions with different binding force or characteristics. Binding of materials to the resins of the present invention are typically determined by the charge of the anion, the size of the anion, the level of the anion in the medium, the pH of the medium, other anions in the medium, and other like parameters. One preferred embodiment of the anion exchange material is an anion exchange resin.

“Uranium” refers to uranium-234, uranium-235 and uranium-238 in uranium anion complexes, including but not limited to: uranium sulfate, and uranium carbonate, and various combinations with other nonmetals and the like.

Embodiments of the present invention provide methods, systems and compositions for removal of target contaminates from an aqueous medium, for example, removal of uranium from a source of ground water, while allowing nitrate to remain in the aqueous medium at relatively or substantially unmodified and constant levels. In general, the methods, systems and compositions of the present invention rely upon treated anion exchange material that selectively absorbs uranium and other like contaminates, while having blocked interactions for nitrate and nitrite. Methods, systems and compositions of the invention prevent build-up and release of nitrate off of an anion exchange material, which can lead to spikes in nitrate levels in the column discharge. Discharged nitrate is often problematic for users if it has been unexpectedly concentrated before release, and bleeds off of the column at non-conforming MCLs (especially during system shut downs).

Embodiments of the present invention rely upon the differential binding interactions between different anions and sites on and in conventional anion exchange material, for example, an anion exchange resin. Aqueous medium can flow through the anion exchange resins in an up-flow, high retention time, system to maximize contact time between the aqueous medium and resin and to minimize or reduce potential for clogging of the resin during such contact time or through a more standard down-flow system. Embodiments of the invention include pre-treating an anion exchange resin with a sufficient amount of “blocking anion” to allow contaminate removal, but inhibit nitrate removal, from an aqueous medium. As contaminates interact with the treated or pre-blocked anion exchange resin, the blocking anions are replaced with contaminate, and ultimately blocking anion is released in the discharge with the nitrate. Conversely, as nitrate moves through the pre-blocked anion exchange resin, it does not replace the blocking anion but rather moves through and out of the column at its feed levels.

Differential Loading Of Contaminates Onto An Anion Exchange Material

The following discussion is provided in the context of removing uranium, or a derivative of uranium, from an aqueous medium, i.e., the contaminate, while, at the same time, allowing nitrate to remain in the aqueous medium at an unaffected and relatively constant level. The scope of the present invention, however, covers methods, systems and compositions for the removal of any target contaminate having a stronger binding interaction with the target anion exchange material than the material to remain, e.g. nitrate. That is, while the description is directed to nitrates and nitrites as the material to remain in the aqueous media, systems that avoid binding other complexes may also be used. Other potential target contaminates include: chromium, vanadium, arsenate, phosphate, and selenium.

Uranium in an aqueous media is typically complexed to carbonate, sulfate or other like compounds to form an uranium anion complex. In only extremely acidic conditions will the uranium exist as a cation. As such, as disclosed in the present invention, the vast majority of uranium in an aqueous media will have absorptive characteristics toward an anion exchange material. The present invention preferably provides optimal weak- and strong-base anion exchange resins for use in absorption of uranium from an aqueous media, for example a ground water supply. In addition, the present invention provides that the aqueous media should be contacted to the resin in a hydraulic up-flow loading that results in optimal expansion of the resin and optimal aqueous media/resin contact time. However, it is also envisioned that down-flow contact may also be used in the context of the present invention.

The present invention provides both a weak-base anion exchange resin and a strong-base anion exchange resin for absorption of uranium from an aqueous media in the presence of nitrate. Anion exchange resins are typically available from Dow Chemical Company, Rohm and Haas, Sybron company, and other like entities. In preferred embodiments, the anion exchange resin is a strong-base anion exchange resin like Dowex 21K, Dow Chemical Co.

Resins of the present invention selectively absorb anions present in the aqueous medium, for example, provide a platform for interaction with a variety of anions, each anion having a binding strength for the resin.

Table 1 provides illustrative selectivity of anions for a target anion exchange resin, such selectivity is utilized to design embodiments of the present invention:

TABLE 1
Illustrative Selectivity of Anions*

| Contaminate | Selectivity |
|---|---|
| UO₂(CO₃)₃⁻⁴ | 2400 |
| CrO₄⁻² | 100 |
| SeO₄⁻² | 17 |
| SO₄⁻² | 9.1 |
| HSO₄⁻ | 4.1 |
| NO₃⁻ | 3.2 |
| *Data are separation of the listed ion versus chloride from 0.01 normal solutions containing 500 mg/L calcium carbonate. Source Duolite Ion Exchange Manual, Diamond Shamrock Chemical Company, Redwood City, CA 1969 (from Ion Exchange Technology, Advances in Pollution | |
| # Control, Arup K. Sengupta, Ed. Technomic Publishing Co., Inc. Page 29, which is incorporated by reference herein in its entirety. (The entire book is incorporated by reference in its entirety.) | |

In one aspect of the invention, an anion exchange material is provided having the capacity to interact with contaminate, blocking anion and nitrate with differing binding strength or selectivity. The contaminate has the strongest binding interaction with the anion exchange resin and is generally removed from the aqueous medium when in contact with the anion exchange resin. Note that a contaminate may be one material, for example uranium, or may include a combination of materials all having a similar binding strength for the anion exchange resin, for example uranium and chromium.

The blocking anion is an anion that typically has a selectivity for an anion exchange material between the selectivity of the contaminate and the selectivity of the nitrate. In addition, blocking anions are typically unregulated or have significantly higher MCLs as compared to nitrate. In preferred embodiments, the blocking anion is sulfate.

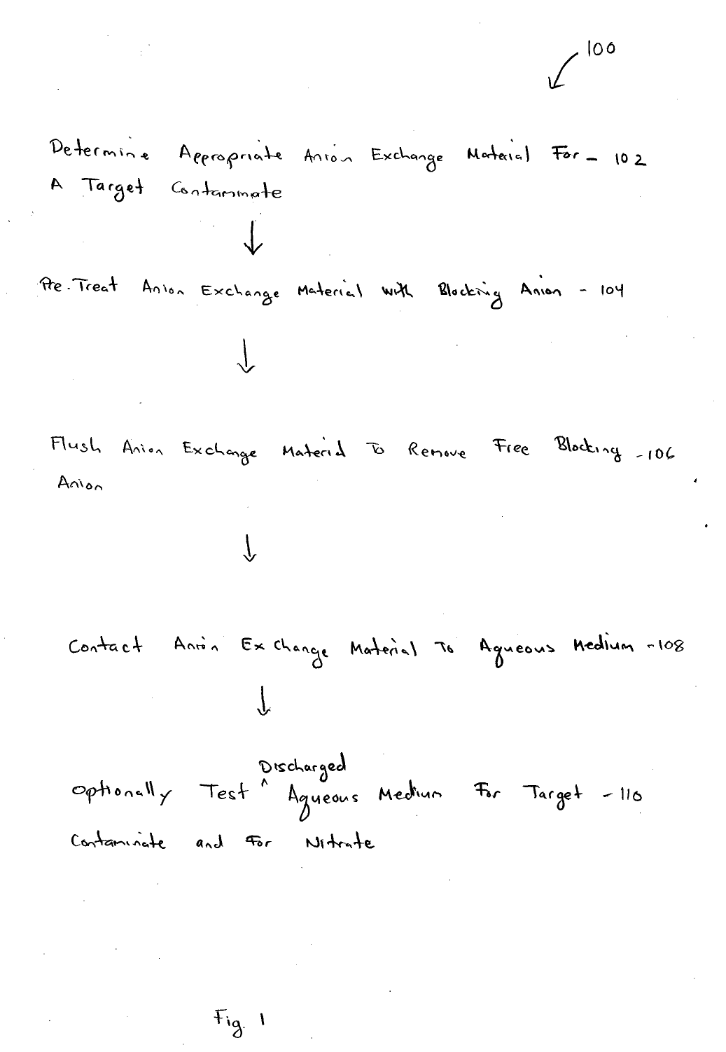

Referring to FIG. 1, a flow diagram 100 is shown in accordance with one embodiment of the present invention. An anion exchange resin is identified for removal of the target contaminate based on the contaminate's selectivity as compared to nitrate 102. A blocking anion is also determined for use with both the identified resin and nitrate based on its selectivity on the resin and other operating conditions, i.e., pH., operating temperature, nitrate levels in the aqueous medium to be treated, other anions in the aqueous medium, etc. Once the appropriate resin and blocking anion have been identified, a saturated or highly concentrated amount of the blocking anion is passed over the resin in order to block some or all of the nitrate binding sites located on the resin 104. Preferably, the blocking anion has a selectivity for the resin in-between the contaminates and nitrate. In order to minimize the amount of blocking anion released into the resin discharge, an optional flush can be used to remove any unbound blocking anion 106. The flushing step can be repeated until the resin is stabilized. The pre-treated anion exchange resin is now ready for use in removal of a target contaminate from an aqueous medium, whereby any nitrate in the medium would be prevented from removal onto the resin by the blocking anion 108. In this way nitrate passes through the resin relatively unaffected, where the contaminate will replace a blocking anion on the resin and thereby be removed from the aqueous medium. In an optional step, the discharged and treated medium is tested for both target contaminate levels and for nitrate levels 110. A discharge having unaffected contaminate levels could be indicative that the resin conditions, and in particular blocking anion levels, prevented contaminate removal from the aqueous medium. A new blocking anion having a lower selectivity for the resin, or a pre-treated resin having a greater number of untreated sites on the resin may be necessary. Further, discharge having reduced levels or modified levels of nitrate would be indicative of a resin that is actively interacting with the resin. Decreased nitrate levels in the discharge is indicative that the blocking anion and nitrate have a selectivity that are to close together for the operating parameters of the identified resin. The amount of blocking anion pre-treated onto the resin may need to be modified or a new type of blocking anion may need to be obtained for use with the resin.

Note that where nitrate levels are consistent due to the methods and systems of the present invention, but above the MCL for nitrate, a second column or remediation step dedicated to nitrate removal may be necessary.

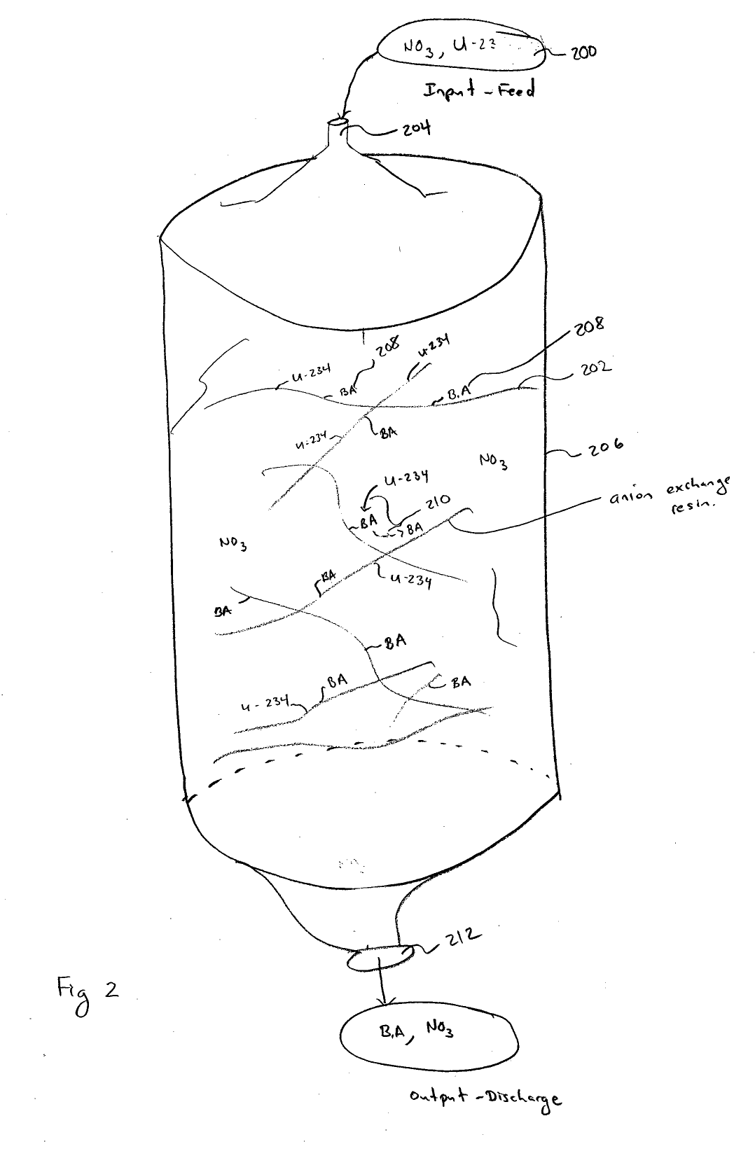

Referring to FIG. 2, an illustrative schematic of one embodiment of the present invention is shown. An aqueous medium 200 having U-234 and nitrate is contacted with the resin 202 via an inlet 204 in a column 206 or other like container. The resin 202 has been pre-blocked with a blocking anion 208, for example, a sulfate group. The aqueous medium at the inlet moves through the resin in a down-flow direction where the U-234 displaces blocking anion due to its higher selectivity for the resin (as illustrated by reference numeral 210). Nitrate, having a lower selectivity for the resin, moves over and through the resin until reaching the outlet 212, where it exits the column 206. An amount of blocking anion exits with the nitrate due to its replacement by the U-234.

For purposes of illustration, approximately 1 kg of weak-base anion exchange resin is required to remove 50,000 mg of uranium from an aqueous source. Approximately 1 kg of strong-base anion exchange resin is required to remove 80,000 mg of uranium from an aqueous source. Resins of the present invention have strong affinity for the absorbed uranium anion complexes, and remain loaded under normal operating conditions.

The 1 kg of strong-base anion exchange resin required to remove 80,000 mg uranium, in accordance with the present invention, is first treated with a saturated solution of sulfate containing medium. For example, a solution of 2 molar sodium sulfate can be run through the resin to pre-block the sites on the resin. The solution has a pH of from about 2 to about 10, and a number of bed volumes, for example from 4-6, should be run through the resin for effective pre-block treatment. Alternative concentrations of blocking anion can be used in conjunction with altered numbers of bed volume of material contacted to the resin.

Systems And Methods For Removal of Uranium, But Not Nitrate, From Aqueous Medium

One embodiment of a system for removing uranium from an aqueous medium using the methods and compositions of the present invention includes having an aqueous medium feed with a first level of uranium in a ground or surface water source. The aqueous medium feed also has a first level of nitrate. The system may include a uranium detection device or sampling device for determining the first concentration of uranium in the aqueous media feed. A storage tank can optionally be present to store aqueous medium prior to treatment with the methods and systems of the present invention. The storage tank can include a float to sense the content within the storage tank. The aqueous media is fed from the supply or storage tank into a column feed pump or other like device to pull the medium from the storage tank and feed it into an anion exchange column in a, for example, upflow fashion. Up-flow parameters, i.e., hydraulic loading, resin type and distribution, column diameters, and the like are pre-determined. Aqueous media flow through the column creates a 25 to 75% resin bed expansion.

Note that filters can be incorporated within the system to facilitate the removal of particulates from the media, including filters between the pump and sorption column and at the top end of the sorption column to minimize the amount of material, e.g., resin, that escapes each column run during bed expansion. It is also noted that the anion exchange column can be connected to a number of anion exchange columns in the system. Each column composition dependent on the hydraulic loading, material type and distribution, and bed expansion. It should be noted that the anion exchange columns can be connected in series or in parallel, dependent on column pressures and flows. A second contaminate detection device can be on the discharge side of the columns to measure the concentration of uranium and/or nitrate in the eluant, referred to as a second solute or contaminate concentration level and second nitrate level respectfully.

A tank or other storage device may also be present for the storage of appropriate blocking anion. Blocking anion is pulled through the anion exchange columns of the present invention prior to use, or during shut down periods, to effectively block nitrate binding sites on the anion exchange material. In some embodiments, a plurality of storage tanks are maintained with the systems of the present invention to provide a variety of blocking anions for use in treating anion exchange materials of the present invention.

Note that the systems of the present invention are generally designed to be incorporated into conventional water treatment systems, and preferably are designed to be incorporated into these systems as stand-alone units. Typically, the incorporation of the systems and methods of the present invention do not require that the existing system be re-designed, but rather, that the removal systems and methods be adapted to function before, during or after more conventional water treatment. Preferably, embodiments of the removal systems and methods of the present invention are added to existing water treatment facilities as a first treatment step. Preferably, embodiments of the present invention remove an amount of uranium from a water source, but leave the amount of nitrate relatively unchanged. Note also that the systems of the present invention are portable and can be designed for transport in trucks or other movable platforms to contaminated sites, for example to a well located in a uranium contaminated ground water area.

The systems and methods of the present invention are adapted for use with existing water treatment plants as a “turn-key” or “bolt-on” process to remove uranium from aqueous media. These facilities can be used to improve the quality of aqueous media in a number of applications, including drinking water, waste water, agricultural water and ground water. In the same manner, the systems and methods of the present invention can be incorporated into new water treatment plant designs, again as “turn-key” or “bolt-on” process to the conventional water treatment facility, or integrated into the facility as designed by one of skill in the art.

In use, a system of the present invention allows for the contact of a feed, having a first level of uranium and a first level of nitrate, with the anion exchange material. The anion exchange material is initially identified for use with an appropriate blocking anion to provide a differential selectivity between the uranium, the blocking anion and the nitrate. The anion exchange material is then treated with an appropriate amount of blocking anion to prevent nitrate removal from the aqueous medium.

The contacting step between the aqueous medium and the treated anion exchange material can be accomplished in a number of ways, for example, and in a continuous manner, where the aqueous medium is fed to the column inlet and allowed to pass through the column (up-flow or down-flow). Preferably, the aqueous medium is contacted with the anion exchange material in an up-flow manner.

During the contact between the aqueous medium and the anion exchange material, uranium anion complex is absorbed to the material thereby decreasing the concentration of the uranium anion complex in the discharged aqueous medium to a second level. In contrast, the nitrate remains at substantially the same level as in the feed, i.e., the first level.

The aqueous medium can be circulated over a second material or resin in a second housing member when the second level of uranium is above a pre-determined threshold value. The aqueous medium can be circulated over the second anion exchange material, until the level of uranium in the aqueous medium is appropriate for discharge from the system. Note that it is likely that the uranium absorption to anion exchange material will likely reach equilibrium in the pass through the first column. In addition, if the nitrate levels in the aqueous medium dip below, or spike above, the nitrate first or feed level, the system may need to be shut down and the column materials replaced with treated anion exchange materials.

Once the anion exchange material is spent, or nearly spent, it is removed from the housing member and disposed of in an approved landfill or re-processed. For purposes of the present invention, anion exchange material is spent when it is no longer effective in absorbing uranium from the aqueous medium to an adequate level. Preferably, spent anion exchange material is removed from the housing member by means of vacuum suction, or other like procedures.

A determination as to whether anion exchange material is spent is monitored by selecting a particular threshold level of uranium, for example the MCL for uranium, and monitoring the level that exits the material. It is also noted, that monitoring of the level of uranium loaded onto the anion exchange material is accomplished by estimating the number of bed volumes required to achieve a desired reduction in concentration of uranium from the aqueous medium and measuring the flow of the aqueous medium through the anion exchange material. The estimation is based on an analysis of the particular aqueous medium composition, the anion exchange material absorption properties, the desired reduction of uranium concentration in the discharge, the anticipated flow rate, the housing member size and the water treatment facility capacity. For example, the aqueous medium would be monitored until a second level of uranium exits the housing member, or by monitoring the flow rate through the housing member. Once the second level of the aqueous medium exceeds the MCL, or the anticipated number of bed volumes is reached, breakthrough occurs.

Another embodiment of the present invention is a system having a pair of housing members, for example columns, having appropriate amounts of anion exchange material, placed in series for the removal of uranium anion complex from an aqueous medium. The system further includes a first uranium or gross alpha monitoring device for determining the first level of uranium, and a second uranium monitoring device for determining the third level of uranium or discharge level of uranium. An additional uranium monitoring device can be included for determining the second level of uranium, or the level of uranium in the aqueous medium before it enters the second housing member, if needed.

It is envisioned that embodiments of the present invention could include additional housing members charged with pre-treated material, e.g., strong-base anion exchange resin depending on the needs of the system, and any number of different combinations of in-series and in-parallel or mixtures of in-series and in-parallel designs are within the scope of the present invention. In addition, combinations of blocking anion can be used to treat an anion exchange material within the same column or one blocking anion can be used to treat a first column, but a second blocking anion used to treat a second column.

It will be clear that the invention is well adapted to attain the ends and advantages mentioned as well as those inherent therein. While a presently preferred embodiment has been described for purposes of disclosure, various changes and modifications may be made which will readily suggest themselves to those skilled in the art and which are encompassed in the spirit of the invention disclosed herein and as defined in the appended claims.

What is claimed is:

1. A method for removing a contaminate from an aqueous medium, the aqueous medium having a first level of the contaminate and a first level of nitrate, the method comprising:
providing an anion exchange material having a stronger selectivity for the contaminate than for nitrate, wherein the anion exchange material selectivity is based on a plurality of interaction sites;
treating the anion exchange material with a blocking anion to block at least a portion of the interaction sites, wherein the anion exchange material has a selectivity for the blocking anion between the selectivity of the contaminate and nitrate; and
loading the aqueous medium onto the anion exchange material;
wherein the contaminate displaces blocking anion and is removed from the aqueous medium and the excess blocking anion and nitrate are substantially not removed from the aqueous medium.

2. A method according to claim 1, wherein the contaminant is uranium.

3. A method according to claim 1 wherein the anion exchange material is a strong base anion exchange resin.

4. A method according to claim 1 wherein the blocking anion is sulfate.

5. A system comprising:
a column comprising an anion exchange material;
wherein the column is adapted to receive an aqueous medium and wherein the anion exchange material is adapted not to remove nitrate from the aqueous medium.
